(19) United States
(12) Patent Application Publication
(10) Pub. No.: US 2026/0212635 A1
(43) Pub. Date: Jul. 23, 2026

(54) METHOD FOR IMAGE SEGMENTATION

(71) Applicant: BETTER MEDICINE OÜ, Teeveere (EE)

(72) Inventor: Dmytro FISHMAN, Tartu (EE)

(21) Appl. No.: 19/143,815

(22) PCT Filed: Nov. 20, 2023
(86) PCT No.: PCT/EP2023/082377

§ 371 Date: Jun. 26, 2025

(30) Foreign Application Priority Data
Dec. 28, 2022 (EP) 22217000.3

(51) Int. Cl. G06V 10/26; G06V 10/25; G06V 10/28; G06V 10/764; G06V 10/774; G06V 10/82; G06V 20/70

(52) U.S. Cl. CPC G06V 10/26; G06V 10/25; G06V 10/28; G06V 10/764; G06V 10/7753; G06V 10/82; G06V 20/70; G06V 2201/03

(57) ABSTRACT

The present invention relates to a method for image segmentation comprising the steps of assigning a label to an image using a neural network; and generating a significance matrix, comprising a set of significance values wherein each significance value is proportional to the significance of an image segment for assigning a label to the image by the neural network, wherein the significance matrix is an output of an image classification model. The invention further relates to a System for image segmentation comprising an indicator module configured to receive an input image and to generate at least one significance matrix for an image class based on the input image, wherein the significance matrix comprises a set of significance values and wherein each significance value is proportional to a significance of an image segment on assigning a label to the image, further comprising a segmentation module configured to generate a segmentation map for the input image based on the at least one significance matrix and the input image to identify at least one image element corresponding to the image class.

### FIELD

The present invention relates to a large-scale general-purpose diagnostic system for imaging data. More specifically, the present invention relates to implementations of machine learning to identify specific attributes or regions of interest in imaging data, in particular medical imaging data.

### BACKGROUND

Pathological characteristics, such as morphology and texture can be heterogeneous such that defining an image as comprising pathological tissue or identifying the type of pathology pose a significant challenge in automated diagnosing of medical images. Furthermore, it can be impractical to comprehensively collect representative examples of all possible types of pathological characteristics, which increases the difficulty of computational modelling.

Strongly supervised convolutional neural networks (CNN) such as U-Net can be implemented for computer vision tasks. However, they can be limited by requirement of having precise pixel-level annotation as an input to guide the network's learning, which can be time-consuming, and may require substantial expertise in manual labelling.

Diagnostics based on medical imaging is a foundational tool in illness recognition and treatment. The acquired images generally require a substantial manual effort to extract information, in particular information relating to pathological deviations. This process is not only time consuming but also prone to human error hindering efficient processing of image data and the corresponding reaction thereto, i.e., treatment. Automatically providing a pixel-level label to medical images, in particular comprising information pertaining to a potential pathology is therefore of great practical interest. Deep convolutional neural networks are state-of-the-art for image segmentation, but require pixel-level annotations, which are time-consuming to produce. The present invention comprises a score-based approach to class activation mapping in combination with a strongly supervised convolutional network, specifically U-Net. Thus, the method provides a pipeline to segment regions in medical images with limited user input. The neural network is trained using only image-level labels. This achieves the advantage that the process incorporated by the invention is faster by orders of magnitude in comparison to training a model in a strongly supervised fashion that includes acquiring pixel-level annotations. Additionally, segmentation performance can be equivalent in comparison to approaches using pixel-level annotations as an input.

Advanced medical imaging devices produce large amounts of datasets with high-resolution visual information. Due to increasing demand in image-based diagnostics, in particular oncological diagnostics, radiologists face an increasing amount of data to review. However, automated analysis to extract information is often hindered by the requirement for pixel-based annotation in training datasets.

While any signal that deviates from an expected non-standard state can be considered pathological, the anomaly can be based on a plurality of possible causes and can manifest in the image in the form of a plurality of aberrations. Manually identifying all the affected images or image regions is a time-consuming solution to this problem. An alternative approach for large datasets can comprise computer-aided delineation and marking of the affected image region. However, defining a complete set of rules that comprehensively describe the plurality of potential pathologies can be a substantial obstacle and can render this option unviable. In particular, the appearance of pathologies in medical images can be random, leading to sparse data and pathology characteristics. In addition, morphology and texture can be often heterogeneous, increasing the difficulty to define a cohesive pathological image region. Therefore, it can be unfeasible to collect representative examples of all possible types of pathologies.

Deep learning can provide a solution to pathology detection while strongly supervised convolutional neural networks can be considered state-of-the-art for most computer vision tasks. However, they may not overcome some challenges that medical imaging analysis brings. A significant bottleneck for the strongly supervised deep learning methods can be their requirement of pixel-level annotation, which can be time-consuming and may require substantial expertise. As an alternative, weakly supervised techniques which involve only image-level labelling can greatly reduce the time needed to prepare the dataset. In particular, generative autoencoder-based models can be trained to identify pathological image data, in particular as areas with large reconstruction error. The method can comprise a one-class classification approach comprising the steps of training a classifier on non-pathological images and flagging pathologies as images with a low probability of belonging to this non-pathological class. Combining the performance advantages of the strongly supervised methods and the convenience of image-level annotations provides a substantial efficiency increase.

### SUMMARY OF THE INVENTION

The present invention provides a combination of advantages of weakly and strongly supervised methods for image segmentation, in particular from medical imaging devices. The present method combines the informative pixel-level and cost-effective generatable image-level annotation to accurately detect anomalies, in particular pathologies in provided input data. Training can be performed using only image-level labels, generating training data which can be orders of magnitude cheaper without a substantial decrease in performance compared to pixel-level data.

The method is based on receiving image-level annotations as input for training, and producing pathology segmentations as an output. The level of input labelling can vary. For example, training dataset can comprise two image classes, i.e., comprising an anomaly and non-anomalous. Alternatively, a plurality of image classes can comprise a plurality of image-level labelled pathologies such that the method can provide pathology specific labelling.

According to the first aspect, the invention relates to a method for image segmentation comprising the steps of assigning a label to input data, in particular an image or image sequence, using a neural network and generating a significance matrix, comprising a set of probability values wherein each probability value is proportional to an impact of the corresponding image segment on assigning a label to the image by the neural network.

The significance matrix can be an activation map. The activation map can be configured to visualize a subset of the input data considered relevant for interpreting the input data. Preferably, an average of a plurality of significance matrices can form an activation map. The basis for the activation map can be an activation function which is configured to determine whether a neuron of the neural network should be activated. This can achieve the advantage of determining whether the information that the neuron is receiving is relevant for the input. The activation function can be a non-linear transformation of the input data. This transformed output can be sent to the next neuron. Activation maps can form a visual representation of activations at various layers of the neural network when processing the input data.

The probability values can indicate a relevance of the corresponding input data section and be relevant for identifying the image as belonging to a specific image class. As such, the probability values can indicate a likelihood of the input data belonging to the specific image class. A label identifying the image class can be assigned to the input data based on evaluating the probability values. The probability values can quantify the statistical significance of the corresponding image section.

The type of label assignable by the method can depend on the set of labels available within an image-level labelled set of training images. A label can represent a particular class of input data. Herein, class activation mapping can indicate at least one discriminative region of the input data relevant to the decision making of the neural network. The class activation map can be constructed using activation maps from a plurality of convolution layers. Preferably, an output of one of the layers of the plurality of convolution layers is provided as an input to the trained neural network which can then output a class probability of the input data belonging to a particular class and/or classes. Additionally, the class probability can be adjusted via projecting back weights onto the activation map of the last convolution layer.

In other words, assigning the label can comprise a class activation mapping method configured to identify discriminative regions by means of linearly weighted combining of activation maps of the neural network. The activation maps can be an output of a corresponding convolutional layer. Alternatively, the neural network can utilize transformers, wherein the activation maps can be an output of a respective transformer. A transformer can be configured to differentially weight a significance of each part of the input data. Aggregating over multiple channels can comprise identifying the importance of each channel with the corresponding weight at the following layer. The following layer can advantageously be a fully connected layer. Alternatively, a fully convolutional approach, preferably with global average pooling can be used.

The method can comprise identifying discriminative regions by means of non-linear complex weighted combining of activation maps of the neural network. The non-linear combining can be based on polynomial functions.

Image segmentation, i.e., the step of segmenting the image, can be defined as dividing a digital image into subgroups, i.e., image segments, reducing the complexity of the image and enabling further processing or analysis of each image segment. Segmenting the image can comprise assigning labels to pixels to identify objects, important elements. In particular, deviations from an expected healthy physiology, i.e., abnormal and/or malignant versions of tissue, cells, organs etc., in the image.

A label can be a contextual data element configured to classify the object. Pertaining to the training of neural networks image-level labels and pixel-level labels can be distinguished. An image-level label or a set of image-level labels can be assigned to the whole image or sequence of images.

The input data can comprise an image sequence, wherein each image is a two-dimensional spatial representation of an object at a corresponding coordinate along a trajectory. The trajectory can include a non-zero component along an axis perpendicular to the two spatial dimensions represented by the respective image. Preferably, the images of the image sequence can correspond to equidistant slices along a z-axis, wherein the image dimensions correspond to an X-axis and a Y-axis.

The method can comprise modifying an image sequence to conform the number of images within an image sequence to a predetermined value. Thereby, the compatibility of the image sequence with the neural network can be increased to yield a better prediction. Specifically, the network can be trained based on a specific spatial distance of the images in the z-direction and/or trained based on a specific number of images forming an image set. Modifying the image sequence can comprise interpolating the image sequence to generate images in between images along the z-axis, preferably in between two adjacent images. Additionally and/or alternatively, modifying the image sequence can comprise interpolating the image set to generate further images, in particular to reach a predetermined number of images within the image set.

For example, a spatially three-dimensional (3D) dataset, i.e., image, can be labelled with an image-level label or a set of image-level labels. The dataset can comprise a plurality of two-dimensional images forming a spatially separated sequence in a third dimension. In other words, the dataset can be composed of a sequence of two-dimensional (2D) images taken at predetermined intervals along a third dimension. Furthermore, an image-level label can be assigned to a single 2D image of a 3D dataset. Additionally, a further image-level label can be assigned to a further 2D image of a 3D dataset, wherein the image-level label and the further image-level label are different. A pixel-level label can be assigned to a specific set of pixels of the input dataset. In particular, a pixel-level label can be assigned to a set of pixels spanning a plurality of 2D images within a 3D image sequence. The dataset can comprise a two-dimensional input image, i.e., two spatial dimensions and at least one value assigned to each two-dimensional coordinate (e.g., a grayscale image). Alternatively, a plurality of values can be assigned to each two-dimensional coordinate (e.g., three colour channels). The 3D-dataset can, for example, be a computer tomography dataset. The 2D dataset can, for example, be a histology dataset.

The method can comprise assigning a single pixel-level label to a cohesive three-dimensional subset of data elements of the input dataset. The cohesive three-dimensional subset can comprise a cohesive section in at least two images, with an overlap of the sections in the third dimension. Herein, an overlap threshold value can be defined according to the minimal ratio of overlapping area. The threshold can vary depending on the separation distance of the two-dimensional images along the third dimension.

The input dataset can comprise a plurality of three-dimensional subsets, wherein each subset comprises two-dimensional representations spaced apart along a respective trajectory or axis, wherein axes of at least two subsets are angled with respect to one another. This can achieve the advantage that medical image scans performed along different trajectories can be linked and a single pixel-level label can be assigned across a plurality of images taken along different axes. Weakly supervised techniques comprising image-level labelling can achieve the advantage of greatly reducing the time needed to prepare the dataset. In particular, generative autoencoder-based models can be trained to identify relevant areas. Thus, the present invention achieves the advantage of combining the performance advantages of strongly supervised methods and the convenience of image-level labels.

The input data can comprise a medical image, preferably a plurality of medical image scans. The medical images can originate from a plurality of sources. For example, histology, computer tomography (CT scan), sonography, magnetic resonance imaging (MRI), positron emission tomography (PET scan), vascular interventional radiography, X-Ray, scintigraphy, single-photon emission computed tomography (SPECT), echocardiography, etc. Preferably, the input data comprises a two-dimensional and/or three-dimensional spatial representation of an object to be processed.

The method can comprise generating at least two significance matrices, in particular a plurality of significance matrices, and/or wherein each significance matrix of the plurality of significance matrices comprises an activation mapping indicating a relevance to an image class or a sub-feature of an image class and/or wherein a predetermined label is assigned to each image class.

For example, an image class identified by a specific label can be defined by a feature and/or a set of sub-features. An activation mapping can indicate the likelihood of the feature or a sub-feature being present in the image, specifically also indicating the location within the image. The significance matrices can achieve the advantage that an image feature can be localized. The image feature can correspond to the class, respective classes in question, and therefore, can provide part of the transition from an image-level label to a pixel-based label. A plurality of significance matrices can be output by the neural network. The significance matrices can be generated by providing the input image to a neural network, in particular a residual network (e.g., ResNet). Preferably, the output of the neural network can be upscaled and/or up-sampled to match the input image dimensions. More specifically, the activation maps extracted from individual convolutional layers of the neural network can be scaled. Each convolutional layer of the neural network can produce an activation map. The neural network can comprise a structure independent from convolutional layers. The neural network can be configured to stepwise transform the dimensions of the input dataset. Preferably, resolution can be decreased and/or depth increased. The network can further comprise a counterpart configured to retransform the dimensions of the input dataset. Activation maps can be extracted at predetermined transformation steps of the neural network.

Each significance matrix can correspond to a specific feature and/or object. Therefore, a plurality of significance matrices can achieve the advantage of identifying a plurality of features and/or objects within a single input dataset. An object can comprise a plurality of features. A plurality of features corresponding to a single image class, i.e., image label, can be identified based on the plurality of significance matrices.

The activation mapping can be configured to mark a specific set of values of the input data which is relevant in identifying the input data belonging to a specific data class, in particular an image class. This achieves the advantage that sections of the input data can be assigned a probability. Each probability value of the activation mapping can correspond to a predetermined number of pixels, i.e., the resolution of the activation mapping can be coarser than the resolution of the input image. Preferably, the activation mapping can be scaled, i.e., interpolated to match the input image resolution. A set of activation mappings can serve as an initial pixel-based annotation input for a postprocessing pipeline and next for a strongly supervised network to generate a pixel-level label. The probability value can correspond to a likelihood of the designated image section to represent a feature of the class label in question.

The significance matrix can be an output of an image classification model (e.g., ResNet, EfficientNet, MobileNet etc.). The image classification model can comprise a plurality of convolutional layers. The significance matrix can be the output of a predetermined convolutional layer of the plurality of convolutional layers. Alternatively, the significance matrix can be aggregated based on a set of convolutional layers of the plurality of convolutional layers. In a preferred embodiment, the output of the last convolutional layer of the image classification model can be the significance matrix. Alternatively, the output of a plurality of convolutional layers of the image classification model can form the significance matrix. This achieves the advantage that image regions considered to be significant to the neural network in classifying the input image can be extracted for further processing. Here, the further processing can be performed by a second stage neural network, in particular a U-net. The second stage neural network is synonymously called a further neural network.

As an example of the second stage neural network, U-net can comprise a 3×3 convolution followed by a non-linear activation function. It uses the valid part of the convolution. Thus, for a 3×3 convolution, a one-pixel border is lost. This achieves the advantage of allowing the processing of large images in individual tiles. This layer can support the extracting characteristics from the data i.e., significant information from the data. The second stage neural network can be configured to process three-dimensional input data. The layers of the second stage neural network can be configured to transform 3D-data. Specifically, a layer can comprise a 3×3×3 convolution and/or the max-pooling layer can comprise a 2×2×2 max-pooling operation.

U-net can comprise a pooling operation, preferably a max-pooling operation, configured to reduce the x-y size of the activation map. For two-dimensional data, the max-pooling can propagate a maximum activation from each 2×2 window to the next activation map. The resulting map can have a factor 2 lower spatial resolution. For three-dimensional data, the pooling can propagate a maximum activation from each 2×2×2 block to the next activation map. Max-pooling can be used to reduce the dimensions of features to extract heavily weighted features. Focussing on heavily weighted features can reduce the required computing power, in particular for parameter learning, and/or decrease the computing complexity.

Preferably, feature channels are scaled by a factor of 2 after each max-pooling operation.

Max-pooling and scaling can provide a sequence of convolutions and spatial contraction of the image. The contraction can provide context of the image. In other words, useful information can be extracted while simultaneously losing spatial information.

An expansion path of the second stage neural network can comprise a series of up-convolutions and concatenation with high-resolution features from the contraction path. The expansion path can be configured to create a high-resolution segmentation map.

Preferably, the up-convolution comprises a learned kernel configured to map each vector to a 2×2 output window, in particular followed by a non-linear activation function. The resulting activation maps can have a factor 2 higher resolution. The up-sampling allows the propagation of more information to the high-resolution layers. For three-dimensional data, the up-convolution can comprise a learned kernel configured to map a matrix to a 2×2×2 output block, which may also be followed by a non-linear activation function.

The sequence of convolutional operations can be followed by concatenations via skip connections. Skip connections can achieve the advantage of providing information about the spatial and structural information of the image.

A final convolution, preferably a 1×1 convolution, can provide a segmentation map, i.e., final segmented image. For 3D-input-data the final convolution can be a 1×1×1 convolution. Advantageously, the segmentation map can comprise two channels, one for foreground and another for background classes. Alternatively, the segmentation map can comprise a plurality of channels. Using unpadded convolutions can yield an output having a smaller resolution than the input image. The combination of a contracting path and expansion path of the U-Net architecture can provide the advantage of extracting useful information of feature mapping and pooling while simultaneously retaining spatial and graphical resolution. This can yield a robust image segmentation.

The second stage neural network can achieve the advantage of reducing the required amount of training data. Thus, the method can circumvent a low availability of biomedical imaging training data while providing increased robustness of the segmentation. The resulting image can be visually comparable to the input image to a high degree. While achieving an image classification with a high probability of the assigned label coinciding with the ground truth.

The significance matrix is an output of a transformer, preferably an attention layer. The attention layer can be configured to dynamically highlight, respectively extract salient parts of the input data. Salient image parts can be characterized by image attributes, including brightness, intensity, contrast, contours, edges, corners, junctions and/or motion. The transformer can comprise an encoder-decoder architecture, comprising a plurality of encoding layers configured to process the input data iteratively, in particular one layer after another and comprising a plurality of decoding layers configured to process the output of the encoder layers iteratively. Each encoder layer can be configured to generate an encoding comprising information about which parts of the input data are relevant to each other. Output of an encoder layer is passed to a subsequent encoder layer as an input. A decoder layer can receive all encodings and can be configured to incorporate contextual information of the encodings to generate an output sequence. Each encoder and/or decoder can comprise an attention function.

The significance matrix can be a probability map, comprising probability values of image sections and/or pixels considered by the neural network for assigning a specific label and/or image class to the image. This achieves the advantage that a basis to form a decision whether the image belongs to a target class can be provided.

The significance matrix in conjunction with the input image can form the input for a strongly supervised segmentation step generating a probability map corresponding to a selected image class. Preferably, the neural network can be a convolutional neural network, in particular a residual network. This can achieve the advantage of avoiding the vanishing/exploding gradient problem. The residual network can comprise residual components comprising a skip-connection configured to connect activations of a layer of the network, i.e. the output of the respective layer, to further layers of the network by skipping at least one layer in between. Thus, an activation forming a result of an activation function of a network layer, in particular a convolutional layer, can be provided as an input activation map to a further network layer. The further network layer is preferably disposed at a different hierarchical level of the network than the network layer. A hierarchical difference can be defined as skipping layers of the same structure, e.g., skipping layers within a decoder or within an encoder. Alternatively, a hierarchical difference can be defined as skipping layers horizontally, e.g., from an encoder structure to a decoder structure. Preferably, the horizontal skip can connect layers of the same depth to achieve a match when concatenating data.

Assigning the label to an image can be weakly supervised. This can be achieved by providing datasets with image-level label only as a training input for the model. Here, weakly supervised can refer to providing only image-level labelling, thereby increasing processing speed and efficiency. In particular, a pixel-level labelling to train the neural network can be omitted. Image-level labels can be provided from existing databases. Herein, images labelled with an image-level label can be used to train the neural network. Preferably, image-level labels can be acquired from centralised databases. In particular medical databases comprising images with assigned diagnosis codes.

The method can comprise creating a pixel-level labelled database based on an image-level database. The method can comprise generating pixel-level labelling data comprising a reference to the corresponding image-level labelled dataset. Each dataset, respectively image, within the updated database can comprise a pixel-level label information identifying a specific set of pixels with a label that corresponds to an existing image-level label.

The method can comprise generating a scaled significance matrix by upscaling, interpolating and/or up-sampling the significance matrix. The scaled significance matrix can match the resolution of the input image. Preferably representing a 1:1 map of pixels to significance values. This achieves the advantage that the significance matrix can be combined with the input image in form of a pixel-by-pixel mapping. The significance matrix can be used as a filter such that a combined output of the significance matrix and the input image comprises a subset of pixels according to a significance threshold.

The method can comprise normalizing the significance matrix, preferably the scaled significance matrix. In particular, a normalization to the range of 0 to 1 can be performed. This can achieve the advantage that a projection of the significance matrix onto the input data, in particular via multiplication, can remove data considered as inconsequential to identifying the image as belonging to the specific image class.

The method can comprise combining the input image with the significance matrix, preferably the scaled significance matrix, more preferably the scaled and normalized significance matrix. This can achieve the advantage that a combined input can be generated which comprises only information relevant to the decision of assigning a specific class or plurality of classes, respectively label or plurality of labels to the input image.

The method can comprise combining the input image and significance matrix to generate a projected image. Preferably, a plurality of projected images from a plurality of significance matrices can be generated. The projected image can form the basis for the classification model, i.e., ResNet, to determine a probability of the input image belonging to a specific class or classes. The classification model can determine a plurality of probabilities for a plurality of corresponding classes. Projecting can comprise combining the input image and the significance matrix. Preferably, the significance matrix is scaled and/or normalized prior to combining with the input image. The significance matrix can act as a filter on the input image, wherein the projected image comprises only image sections considered significant for assigning a label.

Combining the input image and significance matrix can comprise projecting the significance matrix onto the input image, multiplying the significance matrix and the input image, element wise multiplication of the input image and the significance matrix and/or masking of the input image based on the significance matrix. The projection can be an orthogonal projection. The combination of the input image and the significance matrix can comprise filtering the input image based on the significance matrix. For example, the input image can be weighted by the significance matrix, such that only non-zero values of the significance matrix produce a non-zero output in the combined output. This achieves the advantage that relevant data can be extracted from the input image via the significance matrices.

Projecting the significance matrix onto the input image can comprise matching the dimensions of the significance matrix and the input image, preferably upscaling the significance matrix and/or scaling the significance matrix, preferably to a value range from 0 to 1, combining the significance matrix with the image, preferably comprising element-wise multiplication of the significance matrix with the input image.

The method can comprise determining a class probability of the input indicating a likelihood of the input belonging to a specific class or classes of a plurality of image classes, in particular by means of an image classifier, preferably ResNet, preferably based on the projected image. A class probability value can form the basis for labelling the input image with an image-level label. Information regarding the relevant features which lead to the class probability value are indicated in the corresponding significance matrix or matrices.

The method can comprise determining a class probability value for each of at least two classes of the plurality of image classes for the input, in particular by means of an image classifier, preferably ResNet, preferably based on the projected image. This achieves the advantage that a plurality of class probabilities for a predetermined set of classes can be generated. Based on these class probabilities an image-level label can be assigned to the input image.

The method can comprise generating a class probability value for each significance matrix and each class of a plurality of image classes, preferably based on the projected image using a neural network, preferably a CNN.

The class probability value can be an image class score or an image class weight. Thus, the probability value corresponds to a likelihood of the input image being identified as belonging to a specific image class.

The method can comprise performing a combination of the significance matrix and the class probability value to generate a combined significance matrix. The combination can be a linear combination. This achieves the advantage that the significance matrix can be weighted using the probability value. Based on the significance matrix and the respective class probability or class probabilities a class, respectively classes, can be determined for the input image. Preferably the class to be assigned as a label to the input image is determined based on the combined significance matrix. Additionally or alternatively, the significance matrix can be combined with a plurality of class probability values to determine at least one label for the input image. The significance matrices can be combined using a non-linear combination.

The method can comprise aggregating at least two significance matrices to generate an aggregated significance matrix. This can achieve the advantage of combining significance values of at least two class features belonging to a specific class. The aggregated significance matrix can comprise a summed combination of significance matrices configured to provide a map of all data segments considered to be relevant for classifying the input data. Preferably all significance matrices are summed. Aggregating the significance matrix can comprise summing activations generated by the image classification model. Furthermore, aggregating can comprise applying a statistical mean based on a plurality of significance matrices.

The method can comprise weighting the significance matrix based on at least one class probability value, e.g., the largest class probability value. This achieves the advantage that the significance matrices are weighted by a class probability value such that relative impact of significance matrices in comparison to one another is scaled according to the class probability value. This can decrease the likelihood of assigning label to the input image that deviates from a ground truth label of the input image. The significance matrix can be weighted based on a plurality of class probability values, wherein each class probability value corresponds to a specific image class. The image class is preferably identifiable by a specific image label.

The method can comprise combining, i.e., multiplying, each significance matrix of a plurality of significance matrices with at least one corresponding class probability value, e.g., the highest class probability value, representing the most likely image class the image belongs to indicated by the significance matrix. A plurality of class probability values can be combined with the significance matrix.

The method can comprise applying a positive weighting to a predetermined class, i.e., a class of interest, by applying a non-linear function, preferably a rectified linear unit (ReLU), to the significance matrix, in particular the combined significance matrix, preferably by performing a linear combination of maps. The rectified linear unit can perform a rectified linear function. The ReLU can retain positive values of the significance matrix and return zero for non-positive values of the significance matrix.

The method can comprise applying an increase in confidence (CIC) as a class probability value to the significance matrix. The CIC can provide a score corresponding to the significance matrix, i.e., activation maps, on a target class. This can achieve the advantage of removing a dependency on a gradient.

The method can comprise providing the significance matrix, preferably the combined significance matrix, as an input to an encoder, in particular a further neural network, preferably a convolutional network, e.g., a U-Net. The network generating the significance matrices can comprise a set of features of the network used in the U-Net framework. For example, the network can comprise an encoder system of the U-Net framework. The significance matrices in combination with the original input data can form the input to the encoder, i.e., the first layer of the U-Net. The significance matrices are generated as a first step to provide pixel-level context to the further neural network. The significance matrices can serve as pseudo-labels for the U-Net. Specifically, for a given class, respectively label, the significance matrices can provide a transition from a general image-level probability of the image belonging to a specific class to labelling the relevant class element within the image.

The neural network and the further neural network can be of the same type, preferably the neural network and the further neural network comprise a similar structure, preferably network backbone and/or encoder and decoder. The neural networks can preferably incorporate the same classification backbone, in particular a ResNet.

The neural network can comprise a plurality of layers, wherein each layer comprises an activation function configured to transform an input into an activation map. Each transformation can perform a non-linear operation on the input. Additionally and/or alternatively, the activation function can alter the dimensions of the dataset, in particular reduce resolution in two dimensions and increase resolution in a third dimension. The first layer can receive the aggregated significance matrix as an input. Each subsequent layer can receive the activation map output from a preceding layer as an input.

The activation function can comprise a rectified linear unitor a plurality of rectified linear units, forming a rectified linear activation function.

The rectified linear activation function can be a piecewise linear function configured to output the aggregated significance matrix value directly if it is positive, and configured to output zero if it is not positive. Incorporating ReLUs can achieve the advantage increasing the detection performance of the method and/or increase the efficiency of training the neural network.

The method can comprise assigning a pseudo-label to a set of values of the aggregated significance matrix. The significance matrix can provide a basis, in particular in the form of a pseudo-label, for the U-Net to segment objects within the input data. Preferably the same splits of datasets and training procedures can be used.

The pseudo-label can be a label of a cohesive plurality of pixels of the image, in particular a non-context based and/or non-functional pixelwise label. The label can be a marker of a group of data elements differentiating the marked data elements from the further data elements. The pseudo-label can be a unique identifier of the group of data elements. The pseudo-label can be non-contextual in that no class information is attached to the pseudo-label.

The method can comprise generating an output map based on the aggregated significance matrix, in particular using the neural network. The output map can be a segmentation map.

The method can comprise providing the pseudo-label as an input the further neural network, in particular an encoder of the further neural network.

The method can comprise performing a plurality of subsequent convolutions within the encoder, wherein each convolution is followed by an activation function, preferably a non-linear activation function, e.g. a rectified linear unit (ReLU), a leaky ReLU etc., and/or a max pooling operation. Pooling can achieve the advantage of accumulating features from an activation map, in particular generated by convolving a filter over an image, i.e. the activation function. The max pooling operation can reduce the spatial size of the dataset to reduce the number of parameters and the amount of computation in the network, help over-fitting by providing an abstracted form of the representation. Thereby, the computational cost can be reduced by decreasing the number of parameters to learn. Max pooling can comprise applying a max filter, average filter and/or general filter, preferably to non-overlapping subregions of the input dataset.

The further neural network can comprise a strongly supervised model, in particular a U-net architecture. As an example, the network architecture can comprise a contracting path and an expansive path, wherein the contracting path can comprise a plurality of subsequent iterations of two 3×3 convolutions. These convolutions can be unpadded convolutions, wherein each can be followed by a ReLU and/or a pooling operation with stride M for downsampling. As an example N=2 and/or M=2. Depending on the dimensions of the input the convolution dimensions can be adapted (i.e., N×N×N). The pooling can be a max-pooling. For 3D-input data the pooling can have the N×N×N dimensions. With downsampling the number of feature channels can be doubled. Every step in the expansive path consists of an upsampling of the feature map followed by a 2×2 convolution halving the number of feature channels, a concatenation with a correspondingly cropped feature map from the contracting path, and two 3×3 convolutions, each followed by a ReLU. Cropping can compensate to the loss of border pixels per convolution. At the final layer a 1×1 convolution is used to map each 64-component feature vector to the desired number of classes. In total the network can comprise 23 convolutional layers.

The output map can be a segmentation map. The segmentation map can comprise a representation of the input dataset divided into regions, preferably into predefined homogeneous regions. Each region can be assigned a single label. The segmentation map can be spatially continuous, wherein borders between segments can correspond to object boundaries, i.e., boundaries of object representations in the input dataset. The segmentation can be contrast-, colour- and/or shape-based. Additionally or alternatively, the segmentation can be based on texture, location and/or size. Any non-random property of the input data can be used for segmenting the image.

The further neural network can comprise a contracting path, configured to contract at least one dimension of the dataset, respectively image and/or comprise an expansive path. The contracting path can be an encoder and/or the expansive path can be a decoder. The contracting path and the expansive path can be linked via a bottleneck. The contracting path and the expansive path can be configured to preserve the dimensions of the input. For example, the contracting path can receive an image with a specific two-dimensional resolution, preferably a three-dimensional image set with a specific resolution in each dimension, and a specific number of layers, i.e., colour channels, as an input and the expansive path can provide an output having the same two-dimensional resolution and number of layers. The further neural network can be configured to perform a segmentation of the input image, in particular by applying a pixel-level loss function.

The neural network can comprise a plurality of successive layers. This can achieve the advantage that successively linked layers can receive an output of a preceding layer as an input.

The method can comprise segmenting the image based on the significance matrix, preferably the weighted significance matrix, more preferably the aggregated and weighted significance matrix.

Each layer of the contracting path and/or of the expansive path can comprise an activation function. The contracting path can be configured to successively transform the dimensions of the input data, in particular such that two primary dimensions are reduced and a third dimension is enlarged. Correspondingly, the expansive path can be configured to successively transform the dimensions of the input data, in particular such that two primary dimensions are enlarged and a third dimension is reduced. The first layer of the expansive path can be configured to receive the output of the last layer of the contracting path. The output of the last layer of the expansive path can match the input of the contracting path with respect to dimension.

The contracting path can comprise a convolutional network architecture.

The contracting path can comprise a plurality of N×N convolutions for 2D input data and/or a plurality of N×N×N for 3D input data, preferably two unpadded convolutions, in particular with N=3.

Each N×N convolution (N×N×N for 3D input data) can comprise a non-linear function, preferably a ReLU, and/or a M×M max pooling operation (M×M×M for 3D input data), in particular with M=2, with a stride of L, in particular with L=2, for downsampling.

A number of feature channels can be increased, in particular doubled, with each downsampling.

The method can comprise performing at least one N×N convolution (N×N×N for 3D input data) to generate an activation map, i.e., a feature map, wherein the N×N convolution comprises applying a plurality of filters to the input of the N×N convolution, in particular the input image, and wherein a dimension of the generated initial feature map corresponds to the number of applied filters.

The expansive path can comprise a plurality of steps wherein at least one of the steps of the plurality of steps, preferably each step, comprises upsampling of the feature map.

Upsampling can increase the size of the input dataset, i.e., increase the resolution of input image. Upsampling can achieve the advantage of preserving more details and finer structures and thereby increase performance of the network. Upsampling can comprise a bilinear interpolation and/or using a transposed convolutional layer, which is a layer that performs a fractional stride convolution.

Upsampling can comprise creating artificial data points and/or duplicating data points and/or sampling minority classes to simplify the class label. Artificial data points can be created using a variety of oversampling techniques.

The output of a network layer, i.e., an activation map, can be an irregularly distributed sparse depth map which can be upsampled. Upsampling can comprise increasing a sampling rate of the input dataset, i.e., image. At least one of the steps of the plurality of steps, preferably each step, comprises a P×P-convolution, preferably an up-convolution, in particular with P=2, configured to halve the number of feature channels. Also a P×P×P convolution can be implemented for 3D input data.

The P×P, respectively P×P×P, convolution can follow the upsampling.

The expansive path can comprise the step of concatenating the feature map of a corresponding N×N convolution, respectively N×N×N convolution, in the contracting path with the corresponding P×P convolution, respectively P×P×P convolution, of the expansive path.

The method can comprise the step of cropping the feature map of the corresponding N×N convolution to match the dimensions of the P×P convolution, respectively P×P×P convolution, in the expansive path.

The expansive path comprises two Q×Q convolutions, respectively Q×Q×Q convolutions, in particular with Q=3, wherein each convolution is followed by a rectified linear unit.

Each Q×Q convolution, respectively Q×Q×Q convolution, can be configured to decrease a dimension of the input, in particular to decrease a non-spatial dimension, preferably the filter depth.

The expansive path can comprise a final layer comprising a R×R convolution, respectively R×R×R convolution, in particular with R=1, configured to map each S-component feature vector, respectively feature matrix, in particular with S=64, to a plurality of classes, preferably a specific set of classes.

Alternatively, the final layer can comprise a R×R×C convolution when processing two-dimensional input data or a R×R×R×C convolution when processing three-dimensional data. Herein, R can correspond to a spatial dimension of the input data and/or C can correspond to a set of classes. This achieves the advantage that the convolution can be adapted to the spatial dimensionality of the input data and/or process a plurality of classes.

Each class C can correspond to a pathology, respectively pathology category. The convolution can be configured to output volumes of size R×R×R, wherein each volume can be dedicated to a location of each pathology, respectively category. Alternatively, the final layer can be configured to output one volume of size R×R×R with all pathologies marked. A location can be defined as a discrete set of data elements of the input data, i.e., pixels, spanning at least one dimension, i.e., line, area, volume. Preferably, the location is represented by a set of cohesive and/or adjacent data-elements.

The further neural network can comprise at least T convolutional layers, in particular with T=23.

The method can comprise assigning a selected image class, in particular an image class with the highest class probability, to the image.

Assigning an image class to the image when the probability of the respective image class exceeds a probability threshold value.

Binarizing of the significance matrix based on a selected threshold value. The threshold value can be selected to maximize the pixel-wise intersection over Union (IoU) of a validation set. A plurality of thresholds for binarizing can be used for training prior to using the threshold values as pseudo-labels for the secondary neural network, preferably the U-Net model. The method can comprise a tuning step, wherein the threshold value is tuned based on a set of reference images. This achieves the advantage of automatically selecting an optimal binarization threshold value.

The method can comprise identifying a cohesive set of values within the significance matrix, the output map and/or the image as a corresponding cohesive feature, preferably a cohesive region based on the significance matrix, and/or the output map.

The method can comprise identifying a plurality of cohesive sets of values within the significance matrix, the output map and/or the image as corresponding cohesive features, preferably cohesive regions based on the significance matrix, and/or the output map.

The method can comprise assigning a set class value corresponding to an image class to a cohesive feature or a plurality of cohesive features, in particular such that an image class label is converted to a pixel level label.

The method can comprise training a weakly supervised neural network based on at least one medical database that comprises at least one set of images with labels, in particular image level labels, indicating a pathology and/or at least one set of images with labels, in particular image level labels, indicating no pathology.

The image level labels can indicate the type of pathology.

The image level labels can correspond to standardized medical codes in particular ICD-10 codes, indicating a malignancy.

The method can comprise assigning a label to an unlabelled image or a set of unlabelled images, in particular medical scan images wherein assigning a label is weakly supervised and/or wherein an input label can be used to produce a pseudo-label, preferably a pixel-level pseudo label and/or wherein the pseudo label is provided as an input to a segmentation model. Preferably, the label can indicate a pathology.

The image label can be an image wide label and/or wherein the image label indicates a deviation from an image not comprising a pathology.

The method can comprise assigning a pixel-level label to a set of pixels of the image using an activation function, in particular a strongly supervised model, based on the output of the weakly supervised neural network.

The set of pixels can be cohesive or the set of pixels can comprise a plurality of independent cohesive pixel sets.

The pixel-level label can correspond to the image level label and indicates the image region with the highest probability of comprising the pathology.

The method can comprise creating a pixel-level labelled database based on an image-level labelled database. The method can comprise generating pixel-level labelling data comprising a reference to the corresponding image-level labelled dataset. The method can comprise referencing each dataset, respectively image, within the database.

Each image class can comprise a plurality of labels. A plurality of labels can be assigned based on the significance matrix, wherein the labels belong to the same class. Each label can represent an instance and/or sub-class of the image class. For example, a class can comprise a plurality of identifiable instances and/or objects. Each instance and/or object can be assigned a label. The neural network can be configured to identify an instance and/or object and assign the corresponding label to the segmented image section. The neural network can be configured to detect a plurality of classes wherein each class comprises a plurality of labels.

The method can comprise the step of performing a pooling operation, preferably at each layer of the contracting path to reduce the depth of the activation map and/or prior to providing the activation map to a subsequent network element of the contracting path. The pooling operation can be a max-pooling and/or average-pooling operation. The subsequent network element can be a convolutional layer and/or a transformer block.

The method can comprise the step of processing the significance matrix, respectively the combined significance matrix, preferably prior to providing the significance matrix, respectively the combined significance matrix to the further neural network. This achieves the advantage that the significance matrix can be manipulated to increase performance of the further neural network. The processing parameters can be tuned to maximize recognition performance of the further neural network.

Processing the significance matrix can comprise at least one of filtering the significance matrix, applying a computer-vision processing measure and/or removing noise. Filtering can achieve the advantage of increasing cohesion of significant sections, i.e., scattered highly significant sections can be combined. Gradients between highly significant and less significant regions can be modified and/or an edge line of the binarized significance matrix, i.e., the initial pseudo mask can be modified, in particular smoothed and/or modified pertaining to maximum or minimum curvature thresholds.

The input data can comprise a plurality of pathologies and assigning a label to the input data can comprise the step of assigning a plurality of labels, wherein each label of the plurality of labels is assigned to a corresponding pathology of the plurality of pathologies. Preferably, the plurality of pathologies can form a single dataset, i.e., a single medical imaging session, in particular of a single subject. For example, a single computer tomography scan can have multiple pathologies, where a plurality of labels is assigned. This process can be described as multi-label.

The pathologies in the input data can be comprised in a plurality of images or a single image.

The input data can comprise a plurality of data sets, wherein a first set of the plurality of sets comprises a first pathology and a second set of the plurality of sets comprises a second pathology. Assigning a label to the input data can comprise the step of assigning a first label to the first pathology and a second label to the second pathology. A plurality of labels can be assigned to a corresponding plurality of pathologies. One set of input data can describe multiple pathologies. Each set can describe a single pathology. This process can be described as multi-class.

The input data can comprise datasets with multiple pathologies and also comprise sets with different pathologies. Multi-class and multi-label can be combined to a multi-class-multi-label process. For example, a dataset comprising multiple pathologies can comprise medical scans with multiple pathologies on it.

According to a second aspect, the invention relates to a system for image segmentation comprising an indicator module configured to receive an input image and to generate at least one significance matrix for an image class based on the input image, wherein the significance matrix comprises a set of significance values and wherein each significance value is proportional to a significance of an image segment on assigning a label to the image, further comprising a segmentation module configured to generate a segmentation map for the input image based on the at least one significance matrix and the input image to identify at least one image element corresponding to the image class.

The System can comprise a binarization module configured to binarize the significance matrix based on a binarization threshold value.

The indicator module can comprise an image classification component configured to determine a plurality of class probability values. Each class probability value can indicate a likelihood of the input image belonging to the respective class.

The indicator module can be configured to select an image class for the input image based on the plurality of class probability values.

The segmentation module can be configured to identify the at least one cohesive region based on the at least one binarized significance matrix.

The segmentation module can be configured to generate a probability map as a basis to segment the input image into at least two categories. Preferably one category indicates insignificant data elements and wherein a second category indicates significant data elements in reference to the respective image class.

The image element can be a cohesive plurality of image data elements, in particular pixels.

The binarization module can be configured to binarize the output of the image segmentation module based on a further binarization threshold value.

The system can comprise an overlay module configured to combine the input image and the segmentation map to provide a visual indicator of the identified image element.

The indicator module can be configured to receive an input image from a database and wherein the segmentation module is configured to provide the segmentation map and/or a label to the database.

This achieves the advantage that the system can provide label data to the original image database. In particular, the base image used for generating the segmentation map only needs to be transferred to the indicator module, wherein only the segmentation map can be provided back to the database to increase data transfer efficiency and overall processing speed. The system can provide updated labelling to the database. For example, the database can be an archive and/or storage of medical imaging scans. The imaging scans can have an image-level label or no label at all. For example, the archive can be a database of a medical imaging device. The system can interface with the database to process the datasets and return the segmentation maps and/or labels. As such the system can serve as an aid to the examiner in providing not only a diagnosis, preferably in the form of a standardized medical code, i.e., an ICD10 code, but also in highlighting the potential area of the pathology. The segmentation map can be stored separately from the image file so as to not jeopardize the data integrity of the original image. In other words, the overlay of the segmentation map can be provided non-destructively, e.g., as a separate overlay, sidecar file and/or metadata.

The system can be configured to perform the method according to any of the method embodiments.

The system can comprise a data-processing system, wherein the data-processing system is configured to perform the method according to any of the method embodiments.

The data processing system may comprise one or more processing units configured to carry out computer instructions of a program (i.e. machine readable and executable instructions). The processing unit(s) may be singular or plural. For example, the data-processing system may comprise at least one of CPU, GPU, DSP, APU, ASIC, ASIP or FPGA. The data processing system may comprise memory components, such as, main memory (e.g. RAM), cache memory (e.g. SRAM) and/or secondary memory (e.g. HDD, SDD). The data processing system may comprise volatile and/or non-volatile memory such an SDRAM, DRAM, SRAM, Flash Memory, MRAM, F-RAM, or P-RAM. The data processing system may comprise internal communication interfaces (e.g. busses) configured to facilitate electronic data exchange between components of the data processing system, such as, the communication between the memory components and the processing components. The data processing system may comprise external communication interfaces configured to facilitate electronic data exchange between the data processing system and devices or networks external to the data processing system. For example, the data processing system may comprise network interface card(s) that may be configured to connect the data processing system to a network, such as, to the Internet. The data processing system may be configured to transfer electronic data using a standardized communication protocol. The data processing system may be a centralized or distributed computing system. The data processing system may comprise user interfaces, such as:
output user interface, such as:
   screens or monitors configured to display visual data (e.g. displaying graphical user interfaces of the questionnaire to the user),
   speakers configured to communicate audio data (e.g. playing audio data to the user),
input user interface, such as:
   camera configured to capture visual data (e.g. capturing images and/or videos of the user),
   microphone configured to capture audio data (e.g. recording audio from the user),
   keyboard configured to allow the insertion of text and/or other keyboard commands (e.g. allowing the user to enter text data and/or other keyboard commands by having the user type on the keyboard) and/or
   trackpad, mouse, touchscreen, joystick—configured to facilitate the navigation through different graphical user interfaces of the questionnaire.

To put it simply, the data processing system may be a processing unit configured to carry out instructions of a program. The data processing system may be a system-on-chip comprising processing units, memory components and busses. The data processing system may be a personal computer, a laptop, a pocket computer, a smartphone, a tablet computer. The data processing system may be a server, a server system, a portion of a cloud computing system or a system emulating a server, such as a server system with an appropriate software for running a virtual machine. The data processing system may be a processing unit or a system-on-chip that may be interfaced with a personal computer, a laptop, a pocket computer, a smartphone, a tablet computer and/or user interfaces (such as the upper-mentioned user interfaces).

Below, method embodiments will be discussed. These embodiments are abbreviated by the letter “M” followed by a number. Whenever reference is herein made to “method embodiments”, these embodiments are meant.
M1. Method for image segmentation comprising the steps of
   assigning a label to input data, in particular an image or image sequence, using a neural network; and
   generating a significance matrix (activation map), comprising a set of probability values wherein each probability value is proportional to the impact of the corresponding image segment on assigning a label to the image by the neural network.
M2. The method according to the preceding embodiment, # wherein the input data comprises an image sequence, wherein each image is a two-dimensional spatial representation of an object at a corresponding coordinate along a trajectory.
M3. The method according to any of the preceding embodiments, comprising the step of generating at least two significance matrices, in particular a plurality of significance matrices, and/or wherein each significance matrix of the plurality of significance matrices comprises an activation mapping indicating a relevance to an image class or a sub-feature of an image class and/or wherein a predetermined label is assigned to each image class.
M4. The method according to any of the preceding embodiments, wherein the activation mapping is configured to mark a specific set of values of the input data as relevant to identifying the input data as belonging to a specific data class, in particular an image class.
M5. The method according to any of the preceding embodiments, wherein the significance matrix is an output of an image classification model (e.g. ResNet), preferably a convolutional layer, i.e., the last convolutional layer of the image classification model, wherein the output is an activation map.
M6. The method according to any of the preceding embodiments, wherein the significance matrix is an output of a transformer, preferably an attention layer.
M7. The method according to any of the preceding embodiments, wherein the significance matrix is a probability map, comprising probability values of image sections and/or pixels considered by the neural network for assigning a specific label and/or image class to the image.
M8. The method according to any of the preceding embodiments, wherein the significance matrix is generated by a neural network, preferably a convolutional neural network (e.g., Resnet), and wherein the significance matrix in conjunction with the input image forms the input for a strongly supervised segmentation step generating a probability map corresponding to a selected image class.
M9. The method according to any of the preceding embodiments, wherein assigning the label to an image is weakly supervised by providing datasets with image-level label only as a training input for the model.
M10. The method according to any of the preceding embodiments, comprising the step of generating a scaled significance matrix by upscaling, interpolating and/or upsampling the significance matrix and/or wherein the scaled significance matrix matches the resolution of input image, preferably representing a 1:1 map of pixels to significance values.
M11. The method according to any of the preceding embodiments, comprising the step of normalizing the significance matrix, preferably the scaled significance matrix
M12. The method according to any of the preceding embodiments, comprising the step of combining the input image with the significance matrix, preferably the scaled significance matrix, more preferably the scaled and normalized significance matrix.
M13. The method according to any of the preceding embodiments, comprising the step of combining the input image and significance matrix to generate a projected image.
M14. The method according to any of the preceding embodiments, with features of M13, wherein combining the input image and significance matrix comprises projecting the significance matrix onto the input image, multiplying the significance matrix and the input image, element wise multiplication of the input image and the significance matrix and/or masking of the input image based on the significance matrix.
M15. The method according to any of the preceding embodiments, with features of M14, wherein projecting the significance matrix onto the input image, comprises matching the dimensions of the significance matrix and the input image, preferably upscaling the significance matrix, and/or scaling the significance matrix, preferably to a value range from 0 to 1, combining the significance matrix with the image, preferably comprising element-wise multiplication of the significance matrix with the input image.
M16. The method according to any of the preceding embodiments, with features of M13, comprising the step of determining a class probability of the input indicating a probability of the input belonging to a specific class of a plurality of image classes, in particular by means of an image classifier, preferably ResNet, preferably based on the projected image.
M17. The method according to any of the preceding embodiments, with features of M13, comprising the step of determining a class probability value for each of at least two classes of the plurality of image classes for the input, in particular by means of an image classifier, preferably ResNet, preferably based on the projected image.
M18. The method according to any of the preceding embodiments, with features of M13, comprising the step of generating a class probability value for each significance matrix and each class of a plurality of image classes, preferably based on the projected image using a neural network, preferably a CNN.
M19. The method according to any of the preceding embodiments, wherein the class probability value is an image class score or an image class weight.
M20. The method according to any of the preceding embodiments, with features of M18, comprising the step of performing a linear combination of the significance matrix and the class probability value to generate a combined significance matrix.
M21. The method according to any of the preceding embodiments, comprising the step of aggregating at least two significance matrices to generate an aggregated significance matrix.
M22. The method according to any of the preceding embodiments, with features of M18, comprising the step of weighting the significance matrix based on the class probability value, preferably the largest class probability value.
M23. The method according to any of the preceding embodiments, with features of M18, comprising the step of combining, i.e., multiplying, each significance matrix of a plurality of significance matrices with at least one corresponding class probability value, e.g., the highest class probability value, representing the most likely image class the image belongs to indicated by the significance matrix.
M24. The method according to any of the preceding embodiments, comprising the step of applying a positive weighting to a predetermined class (class of interest) by applying a non-linear function, preferably a ReLU (rectified linear unit), to the significance matrix, in particular the combined significance matrix, preferably by performing a linear combination of maps.
M25. The method according to any of the preceding embodiments, with features of M18, comprising the step of applying an increase in confidence (CIC) as a class probability value to the significance matrix.
M26. The method according to any of the preceding embodiments, comprising the step of providing the significance matrix, preferably the combined significance matrix, as an input to an encoder, in particular a further neural network, preferably a convolutional network, more preferably to an activation function of a U-Net.
M27. The method according to any of the preceding embodiments, with features of M26, wherein the neural network and the further neural network comprise a similar structure, preferably network backbone and/or encoder and decoder.
M28. The method according to any of the preceding embodiments, wherein each layer comprises an activation function configured to transform an input into an activation map.
M29. The method according to any of the preceding embodiments, wherein the activation function comprises a rectified linear unit or a plurality of rectified linear units, forming a rectified linear activation function.
M30. The method according to any of the preceding embodiments, with features of M29, wherein the rectified linear activation function is a piecewise linear function configured to output the aggregated significance matrix value directly if it is positive, and configured to output zero if it is not positive.
M31. The method according to any of the preceding embodiments, comprising the step of assigning a pseudo-label to a set of values of the aggregated significance matrix.
M32. The method according to any of the preceding embodiments, with features of M31, wherein the pseudo-label is a label of a cohesive plurality of pixels of the image, in particular a non-context based and/or non-functional pixelwise label.
M33. The method according to any of the preceding embodiments, with features of M21 and M26, comprising the step of generating an output map based on the aggregated significance matrix, in particular using the further neural network.
M34. The method according to any of the preceding embodiments, with features of M31, comprising the step of providing the pseudo-label as an input to the further neural network, preferably an encoder of the further neural network.
M35. The method according to any of the preceding embodiments, with features of M26, comprising the step of performing a plurality of subsequent convolutions within the encoder, wherein each convolution is followed by an activation function, preferably a non-linear activation function, e.g. a rectified linear unit and/or a max pooling operation.
M36. The method according to any of the preceding embodiments, with features of M26, wherein the further neural network comprises a strongly supervised model.
M37. The method according to any of the preceding embodiments, with features of M33, wherein the output map is a segmentation map.
M38. The method according to any of the preceding embodiments, with features of M33, wherein the neural network can comprise a contracting path, configured to contract at least one dimension of the dataset, respectively image, and/or comprise an expansive path.
M39. The method according to any of the preceding embodiments, with features of M26, wherein the neural network and/or the further neural network comprise a plurality of successive layers.
M40. The method according to any of the preceding embodiments, comprising the step of segmenting the image based on the significance matrix, preferably the weighted significance matrix, more preferably the aggregated and weighted significance matrix.
M41. The method according to any of the preceding embodiments, with features of M38, wherein each layer of the contracting path and/or of the expansive path comprises an activation function.
M42. The method according to any of the preceding embodiments, with features of M38, wherein the contracting path comprises a convolutional network architecture.
M43. The method according to any of the preceding embodiments, with features of M38, wherein the contracting path comprises a plurality of N×N convolutions, preferably two unpadded convolutions, in particular with N=3.
M44. The method according to any of the preceding embodiments, with features of M43, wherein each N×N convolution comprises a non-linear function, preferably a rectified linear unit (ReLU), and/or a M×M max pooling operation, in particular with M=2, with a stride of L, in particular with L=2, for downsampling.
M45. The method according to any of the preceding embodiments, with features of M44, wherein a number of feature channels is increased, in particular doubled, with each downsampling.
M46. The method according to any of the preceding embodiments, comprising the step of
   performing at least one N×N convolution to generate an activation map, i.e., a feature map, wherein the N×N convolution comprises applying a plurality of filters to the input of the N×N convolution, in particular the input image, and wherein a dimension of the generated initial activation map corresponds to the number of applied filters.
M47. The method according to any of the preceding embodiments, with features of M38, wherein the expansive path comprises a plurality of steps and wherein at least one of the steps of the plurality of steps, preferably each step, comprises upsampling of the feature map.
M48. The method according to any of the preceding embodiments, with features of M47, wherein at least one of the steps of the plurality of steps, preferably each step, comprises a P×P-convolution, preferably an up-convolution, in particular with P=2, configured to halve the number of feature channels.
M49. The method according to any of the preceding embodiments, with features of M49, wherein the P×P convolution follows the upsampling.
M50. The method according to any of the preceding embodiments, with features of M46, wherein the expansive path comprises the step of concatenating the activation map of a corresponding N×N convolution in the contracting path with the corresponding P×P convolution of the expansive path.
M51. The method according to any of the preceding embodiments, with features of M46, comprising the step of
   cropping the activation map of the corresponding N×N convolution to match the dimensions of the P×P convolution in the expansive path.
M52. The method according to any of the preceding embodiments, with features of M38, wherein the expansive path comprises two Q×Q convolutions, in particular with Q=3, wherein each convolution is followed by a rectified linear unit.
M53. The method according to any of the preceding embodiments, with features of M52, wherein each Q×Q convolution is configured to decrease a dimension of the input, in particular to decrease a non-spatial dimension, preferably the filter depth.
M54. The method according to any of the preceding embodiments, with features of M38, wherein the expansive path comprises a final layer comprising a R×R convolution, in particular with R=1, configured to map each S-component feature vector, in particular with S=64, to a plurality of classes, preferably a specific set of classes.
M55. The method according to any of the preceding embodiments, with features of M26, wherein the further neural network comprises at least T convolutional layers, in particular with T=23.
M56. The method according to any of the preceding embodiments, comprising the step of assigning a selected image class, in particular an image class with the highest class probability, to the image.
M57. The method according to any of the preceding embodiments, comprising the step of assigning an image class to the image when the probability of the respective image class exceeds a probability threshold value.
M58. The method according to any of the preceding embodiments, comprising the step of Binarizing of the significance matrix based on a selected threshold value.
M59. The method according to any of the preceding embodiments, comprising the step of identifying a cohesive set of values within the significance matrix, the output map and/or the image as a corresponding cohesive feature, preferably a cohesive region based on the significance matrix, and/or the output map.
M60. The method according to any of the preceding embodiments, comprising the step of identifying a plurality of cohesive sets of values within the significance matrix, the output map and/or the image as corresponding cohesive features, preferably cohesive regions based on the significance matrix, and/or the output map.
M61. The method according to any of the preceding embodiments, with features of M60, comprising the step of assigning a set class value corresponding to an image class to a cohesive feature or a plurality of cohesive features, in particular such that an image class label is converted to a pixel level label.
M62. The method according to any of the preceding embodiments, comprising the step of training a weakly supervised neural network based on at least one medical database that comprises at least one set of images with labels, in particular image level labels, indicating a pathology and/or at least one set of images with labels, in particular image level labels, indicating no pathology.
M63. The method according to any of the preceding embodiments, with features of M62, wherein the image level labels indicate the type of pathology.
M64. The method according to any of the preceding embodiments, with features of M62, wherein the image level labels correspond to standardized medical codes indicating a malignancy.
M65. The method according to any of the preceding embodiments, comprising the step of testing a plurality of image labels and/or image classes for an input image comprising determining a probability value per image label respectively image class and/or assigning a label to an unlabelled image, i.e. the input image, in particular wherein the input image is a medical scan image, wherein assigning a label is weakly supervised and/or wherein an input label can be used to produce a pseudo-label, preferably a pixel-level pseudo label and/or wherein the pseudo label is provided as an input to a segmentation model.
M66. The method according to any of the preceding embodiments, with features of M65, comprising the step of transforming the assigned image-level label into a pixel-level label on the basis of the significance matrix, wherein the label indicates a pathology.
M67. The method according to any of the preceding embodiments, with features of M66, wherein the image label is an image wide label and/or wherein the image label indicates a deviation from an image no comprising a pathology.
M68. The method according to any of the preceding embodiments, with features of M66, comprising the step of assigning a pixel level label to a set of pixels of the image, wherein the set of pixels is cohesive or wherein the set of pixels comprises a plurality of independent cohesive pixel sets.
M69. The method according to any of the preceding embodiments, with features of M66, wherein the pixel-level label corresponds to the image level label and indicates the image region with the highest probability of comprising the pathology.
M70. The method according to any of the preceding embodiments, wherein each image class comprises a plurality of labels.
M71. The method according to any of the preceding embodiments, comprising the step of performing a pooling operation, preferably at each layer of the contracting path to reduce the depth of the activation map and/or prior to providing the activation map to a subsequent convolutional layer of the contracting path.
M72. The method according to any of the preceding embodiments, with features of M26, comprising the step of
   processing the significance matrix, respectively the combined significance matrix, preferably prior to providing the significance matrix, respectively the combined significance matrix to the further neural network.
M73. The method according to any of the preceding embodiments, with features of M72, wherein processing the significance matrix comprises at least one of
   filtering the significance matrix;
   applying a computer-vision processing measure;
   removing noise.
M74. The method according to any of the preceding embodiments, wherein the input data comprises a plurality of pathologies and wherein assigning a label to the input data comprises the step of assigning a plurality of labels, wherein each label of the plurality of labels is assigned to a corresponding pathology of the plurality of pathologies.
M75. The method according to any of the preceding embodiments, wherein the input data comprises a plurality of data sets, wherein a first set of the plurality of sets comprises a first pathology and a second set of the plurality of sets comprises a second pathology, and wherein assigning a label to the input data comprises the step of assigning a first label to the first pathology and a second label to the second pathology.

Below, system embodiments will be discussed. These embodiments are abbreviated by the letter “S” followed by a number. Whenever reference is herein made to “method embodiments”, these embodiments are meant.
S1. System for image segmentation comprising
an indicator module configured to receive an input image and to generate at least one significance matrix for an image class based on the input image, wherein the significance matrix comprises a set of significance values and wherein each significance value is proportional to a significance of an image segment on assigning a label to the image, further comprising
a segmentation module configured to generate a segmentation map for the input image based on the at least one significance matrix and the input image to identify at least one image element corresponding to the image class.
S2. System according to the preceding embodiment, comprising a binarization module configured to binarize the significance matrix based on a binarization threshold value.
S3. System according to any of the preceding embodiments, wherein the indicator module comprises an image classification component configured to determine a plurality of class probability values, wherein each class probability value indicates a likelihood of the input image belonging to the respective class.
S4. System according to any of the preceding embodiments, with features of S3, wherein the indicator module is configured to select an image class for the input image based on the plurality of class probability values.
S5. System according to any of the preceding embodiments, with features of S2, wherein the segmentation module is configured to identify the at least one cohesive region based on the at least one binarized significance matrix.
S6. System according to any of the preceding embodiments, wherein the segmentation module is configured to generate a probability map as a basis to segment the input image into at least two categories, wherein one category indicates insignificant data elements and wherein a second category indicates significant data elements in reference to the respective image class.
S7. System according to any of the preceding embodiments, wherein the image element is a cohesive plurality of image data elements, in particular pixels.
S8. System according to any of the preceding embodiments, with features of S2, wherein the binarization module is configured to binarize the output of the image segmentation module based on a further binarization threshold value.
S9. System according to any of the preceding embodiments, comprising on overlay module configured to combine the input image and the segmentation map to provide a visual indicator of the identified image element.
S10. System according to any of the preceding embodiments, wherein the indicator module is configured to receive an input image from a database and wherein the segmentation module is configured to provide the segmentation map and/or a label to the database.
S11. The system according to any of the preceding system embodiments, wherein the system is configured to perform the method according to any of the method embodiments.
S12. The system according to any of the preceding system embodiments, comprising a data-processing system, wherein the data-processing system is configured to perform the method according to any of the method embodiments.

Below, embodiments of a computer program product will be discussed. These embodiments are abbreviated by the letter “C” followed by a number. Whenever reference is herein made to the “computer program product embodiments”, these embodiments are meant.
C1. A computer program product comprising instructions, which, when executed by a system, preferably a data-processing system, and any of its components according to any of the system embodiments, cause the system and its components to perform the steps, for which the system and/or any of its components are configured.
C2. A computer program product comprising instructions, which, when executed by the data-processing system and preferably any of its components according to any of the system embodiments, cause the data-processing system and its respective components to perform the steps of the method according to any of the method embodiments, which method steps are performed by the data-processing system and/or the respective components according to the method.

Below, use embodiments will be discussed. These embodiments are abbreviated by the letter “U” followed by a number. Whenever reference is herein made to “use embodiments”, these embodiments are meant.
U1. Use of the system according to any of the preceding embodiments, for carrying out the method according to any of the preceding method embodiments.
U2. Use of the method according to any of the method embodiments and the system according to any of the preceding embodiments, for medical imaging data.
U3. Use of the method according to any of the method embodiments for processing medical image datasets as input-data to generate a pixel-level labelled dataset.
U4. Use of the method according to any of the method embodiments and/or the system according to any of the system embodiments for pathology detection in a medical image dataset.
U5. Use of the method according to any of the method embodiments and/or the system according to any of the system embodiments for generating a visual aid, preferably an image overlay and/or a pathology label to mark an image section of a medical image.

### BRIEF DESCRIPTION OF FIGURES

The present invention will now be described with reference to the accompanying drawings, which illustrate embodiments of the invention. These embodiments should only exemplify, but not limit, the present invention.

FIG. 1 schematically depicts an embodiment of the method according to the present invention;

FIG. 2 schematically depicts an embodiment of the method according to the present invention; and

FIG. 3 schematically depicts an embodiment of the method according to the present invention.

### DETAILED DESCRIPTION OF FIGURES

It is noted that not all the drawings carry all the reference signs. Instead, in some of the drawings, some of the reference signs have been omitted for sake of brevity and simplicity of illustration. Embodiments of the present invention will now be described with reference to the accompanying drawings.

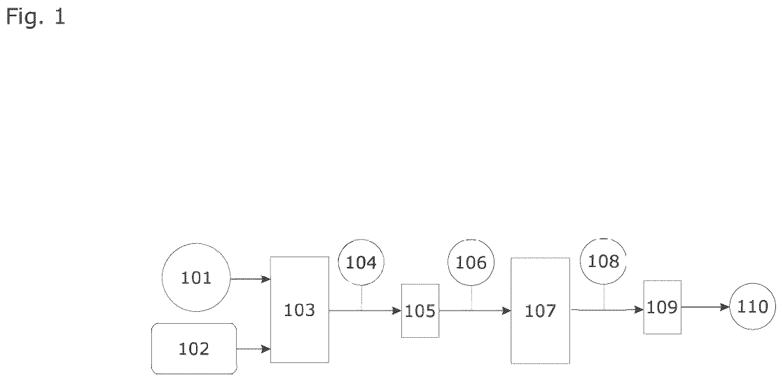

FIG. 1 schematically depicts an embodiment of the method for image segmentation comprising the steps of assigning a label to an image using a neural network 103, 107 and generating a significance matrix 104, comprising a set of significance values wherein each significance value is proportional to the significance of an image segment for assigning a label to the image by the neural networks 103, 107. The significance matrix 104 is an output of an image classification model.

During training of the image classification model, implemented via the neural network 103, the model can output pixel-level significance matrices, i.e., probability maps, for images which are assigned an image-level label 102. A binarized significance matrix 106 can be provided to the further neural network 107 as an input to perform a segmentation of the input image 101. Based on the segmentation, the image-level label 102 can be transformed into a pixel-level label. The neural network 103, i.e. the image classifier, can output the significance matrix 104 which is subsequently binarized 105 to generate a binarized significance matrix 106. The input image can be provided in conjunction with the binarized significance matrix 106 to the further neural network 107 as an input. The binarized significance matrix 106 can perform as a pseudo-label input for the further neural network. Herein, the binarized significance matrix 106 can represent a region of interest the further network 107 can base the decision of assigning a pixel-level label on.

The further neural network 107 can generate a probability map 108 as an output. The probability map 108 can subsequently be binarized 109 to generate a final binary mask 110 representing a pixel-level label. The pixel-level label can correspond to one of the trained labels, wherein training data was provided in the form of images with image-level labels.

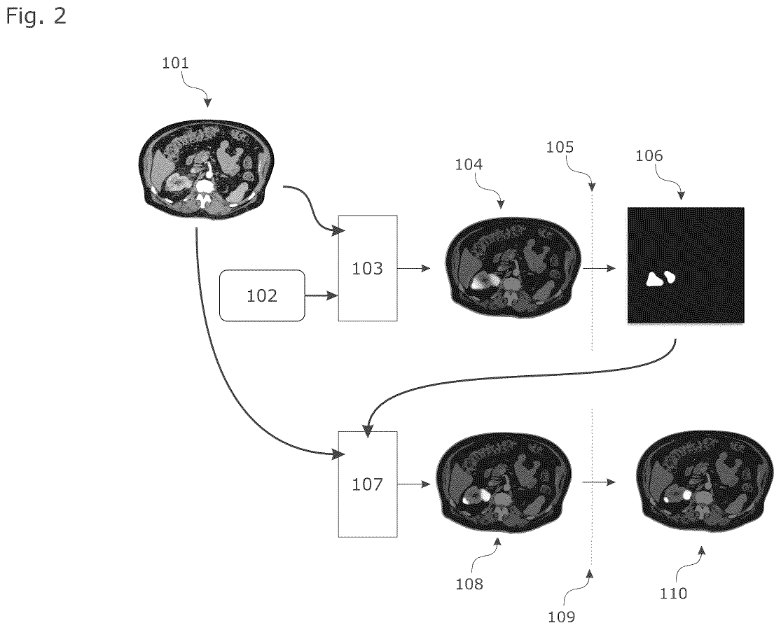

FIG. 2 depicts a schematic representation of a medical imaging embodiment of the method according to the invention. Medical images, in particular training images, 101 and corresponding image-level labels 102, preferably medical diagnostic codes, more preferably weak labels in the form of ICD10 codes, can be provided as an input to the image classification 103. The image classification 103 can be a Score-CAM framework.

The present invention, in particular the weakly supervised image classification via a residual network, provides the advantage that areas of the image are highlighted that are considered most useful for differentiating between the image classes, i.e., pathologic and non-pathologic images. The subsequent strongly supervised neural network, i.e., U-Net, can be configured to directly classifies pixels into categories.

As a first step the method comprises a step to extract predictions made by deep learning methods applied to models that perform image classification. The model output and the corresponding image are analysed and parts of the image that had a large impact for the particular prediction are highlighted. This highlighted prediction map can be provided in the form of a significance matrix 104. For reference, the initial probability maps 104 are shown as an overlay on top of a darkened version of the base training image. The initial probability map 104 is shown as a white overlay. The extraction step can comprise four sub-steps. First, extracting visual representations, in particular in form of activation maps 104 of the last convolutional layer from an image classification model, e.g., ResNet. Secondly, upscaling each activation map to match the size of the input image, normalizing to a range between 0 and 1, and projecting onto a copy of the input image, preferably via multiplication, producing a projected input image. Thirdly, calculating the probability of the input image belonging to each class using the classification model based on projected inputs. Finally, summing all activation maps, each multiplied by the corresponding class-largest probability and passed through a ReLU activation function to generate the output. Not using gradients, the prediction can be based on the largest class probability to obtain the resulting map. This can decrease noise in the output. The significance matrix 104 can be subjected to a binarization based on a predetermined binarization threshold value, i.e., 0.5, to produce an initial pseudo-mask 106. This mask can be provided in conjunction with the original source image 101 to the further neural network 107. The further neural network 107 can achieve segmentation of the image 101 and associate a label to its output probability map 108. The output probability map is also shown as a white overlay over a darkened version of the input image to achieve tonal separation. A further binarization 109 can be applied to the output probability map 108 to yield the final resulting mask 110 comprising a pixel-level label with a sharp boundary. Again the resulting mask is shown as a white overlay over a darkened version of the input image.

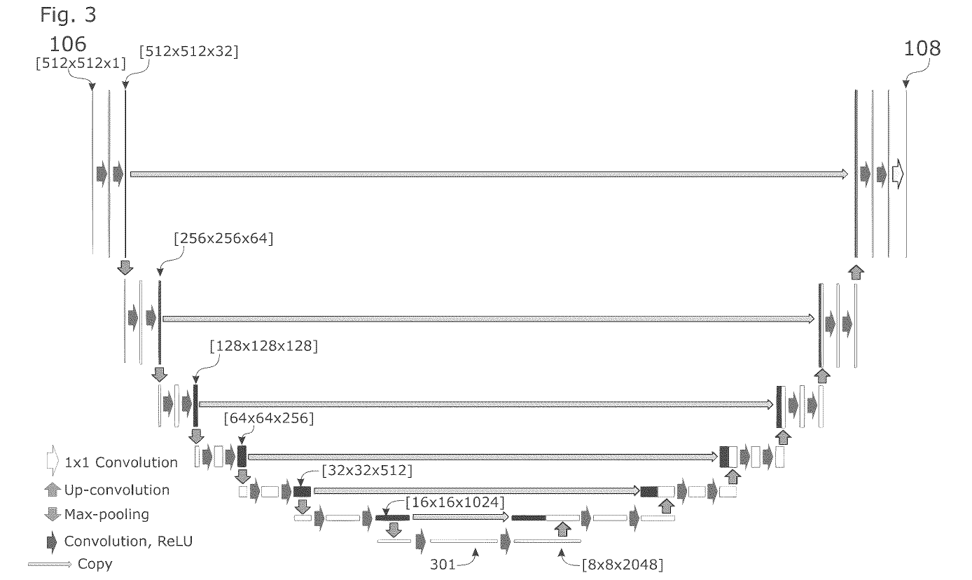

FIG. 3 depicts a schematic representation of a neural network, in particular a further neural network according to the invention. In this example a U-Net. Herein, U-Net represents one possible embodiment according to the invention. The present invention is not limited to the implementation of U-Net. Any neural network configured to process a significance matrix to output a probability map 108 can be used. The strongly supervised U-Net component can consist of an encoder and a decoder which are connected via a bottleneck 301. The encoder can a contracting path and the decoder can be an expansive path. Furthermore the network comprises skip links configured to pass a signal from the encoder to the decoder. Each skip link is represented as a copy process, wherein an output of the respective convolutional layer of the contracting path is copied to a same level convolutional layer of the expansive path. The output of the convolutional layer can be an activation map generated via a non-linear activation function. This activation map can be concatenated with the output of a respective convolutional layer of the expansive path one level below the copy link.

As an example input a square image with a resolution of 512 pixels and one channel, i.e., greyscale is shown. As indicated by two subsequent arrows, each convolution can be followed by a non-linear function, in particular a rectified linear unit (ReLU). The convolution can be a 3×3 convolution. The output of the non-linear function is the input to a max-pooling function which can reduce the spatial resolution. The convolution increases the depth, in particular doubles the depth. On the decoder side, an up-convolution can increase the resolution. The concatenated input to each convolutional layer of the decoder can be halved in depth per layer. Subsequently a nonlinear function is again applied for each layer and then up-scaled by the up-convolution. At the final layer of the decoder a 1×1 convolution can be applied to receive the output segmentation map.

The encoder is the first half of the shown architecture diagram comprising a pre-trained classification network, e.g., ResNet, comprising convolutional layers followed by a maxpool downsampling to encode the input image into feature representations at multiple different levels. The decoder is the second half of the architecture configured to semantically project the discriminative features—present in reduced resolution—learnt by the encoder onto the pixel space—present in higher resolution—to get a dense classification. The decoder can consist of upsampling and concatenation followed by regular convolution operations.

The encoder can comprise 15 convolutional layers comprising convolutional filters of size 3×3 and a ReLU activation function. After every third layer, the encoder comprises a 2×2 max-pooling layer and a skip connection to the decoder.

Symmetrically, the decoder can comprise 15 convolutional layers with ReLU activation functions. After every third convolutional layer, the decoder comprises an upsampling layer configured to upscale its input dimensions, i.e., image height and image width by a factor of 2. Upsampling can achieve the advantage of restoring the condensed feature map to the original size of the input image by expanding the feature dimensions. Upsampling can be referred to as transposed convolution, upconvolution, or deconvolution. Upsampling methods can comprise nearest neighbour, bilinear interpolation, and/or transposed convolution methods.

Finally, the bottleneck after the encoder comprises three convolutional layers. Each convolutional layer can comprise N filters, in particular 64 filters. This can apply to each convolutional layer in the encoder, decoder, and/or bottleneck.

For training, the ResNet50 classification model can be trained to classify non-pathological and pathological images. The model can be trained on a plurality of datasets.

The output of the classification is binarized with the threshold, in particular a threshold of 0.05, and used as pseudo-labels for the U-Net, which was subsequently trained to segment the labelled regions using the same splits of the datasets used for the training procedure. The training can be performed using different thresholds for binarizing prior to providing the output as pseudo-labels for the U-Net as input.

The present invention realizes the advantage of providing scalability such that pixel-level image labelling can be obtained automatically and efficiently. In particular manual screening of images can be replaced by the method according to the invention. Additionally, the present method is capable of processing quantities of images that would be prohibitively expensive to process manually. The neural network can be trained to differentiate between different types of pathologies.

1. Method for image segmentation comprising the steps of:
assigning a label to an image using a neural network; and
generating a significance matrix, comprising a set of significance values wherein each significance value is proportional to the significance of an image segment for assigning a label to the image by the neural network,
wherein the significance matrix is an output of an image classification model.

2. The method according to claim 1, further comprising the steps of:
combining the input image and significance matrix to generate a projected image; and
determining a class probability of the image belonging to a specific class of a plurality of image classes based on the projected image.

3. The method according to claim 2, further comprising the steps of:
generating at least two significance matrices;
summing the at least two significance matrices to generate an aggregated significance matrix;
determining a class probability of the image belonging to a specific class of a plurality of image classes based on the projected image; and
performing a combination of the significance matrix and the class probability value to generate a combined significance matrix.

4. The method according to claim 3 further comprising the step of:
assigning a pseudo-label to a set of values of the aggregated significance matrix, wherein the pseudo-label is a label of a cohesive plurality of pixels of the image.

5. The method according to claim 1, further comprising the step of:
segmenting the image based on the significance matrix by means of a strongly supervised neural network, comprising a contracting path and an expansive path;
wherein the contracting path comprises convolutional layers performing a non-linear activation function, wherein each layer performs a resolution reduction and increases the depth of the activation, and
wherein the expansive path comprises further convolutional layers performing a non-linear activation function, wherein each layer performs a resolution increase and decreases the depth of the activation.

6. The method according to claim 5, further comprising the step of:
performing a pooling operation at each layer of the contracting path to reduce the depth of the activation map prior to providing the activation map to a subsequent network element of the contracting path.

7. The method according to claim 5, further comprising the step of:
performing an up-scaling operation at each layer of the expansive path to increase the resolution of the activation map prior to providing the activation map to a subsequent convolutional layer of the expansive path.

8. The method according to claim 5, wherein the expansive path comprises a final layer comprising an R×R×R×C convolution configured to map each feature vector of an input to a plurality of classes to generate an output map per class.

9. The method according to claim 1, further comprising the steps of:
assigning an image class to the image when the probability of the respective image class exceeds a probability threshold value; and
identifying a cohesive set of values within the output map as a corresponding cohesive feature; and
assigning a set class value corresponding to an image class to the cohesive feature.

10. The method according to claim 1, further comprising the step of:
feeding a plurality of images each comprising an image-level label of a plurality of image-level labels to a neural network configured to generate the significance matrix; and
training the neural network to apply an image-level label to from the plurality of image-level labels to an unlabelled image.

11. The method according to claim 1, further comprising the step of:
assigning the image-level label to a significant region identified by the activation map to identify the significant image region as the indicator for the assigned image-level label.

12. System for image segmentation comprising:
an indicator module configured to receive an input image and to generate at least one significance matrix for an image class based on the input image, wherein the significance matrix comprises a set of significance values, and wherein each significance value is proportional to a significance of an image segment on assigning a label to the image, and
a segmentation module configured to generate a segmentation map for the input image based on the at least one significance matrix and the input image to identify at least one image element corresponding to the image class.

13. The system according to claim 12, further comprising a binarization module configured to binarize the significance matrix based on a binarization threshold value.

14. The system according to claim 12, wherein the indicator module comprises an image classification component configured to determine a plurality of class probability values, wherein each class probability value indicates a likelihood of the input image belonging to the respective class or classes.

15. The system according to claim 12, wherein the segmentation module is configured to generate a probability map as a basis to segment the input image into at least two categories, wherein one category indicates insignificant data elements and wherein a second category indicates significant data elements in reference to the respective image class.
